(19) United States
(12) Patent Application Publication
(10) Pub. No.: US 2023/0332925 A1
(43) Pub. Date: Oct. 19, 2023

(54) METHODS AND APPARATUS FOR CALIBRATING SENSORS ON AN AUTONOMOUS VEHICLE

(71) Applicant: Nuro, Inc., Mountain View, CA (US)

(72) Inventors: Jessica Rose Yox, Mountain View, CA (US); Laszlo-Peter Berczi, Mountain View, CA (US); Chunshang Li, Mountain View, CA (US); Jeremy Wong, Mountain View, CA (US); Cong Li, Mountain View, CA (US); Patrick Pei, Mountain View, CA (US)

(73) Assignee: Nuro, Inc., Mountain View, CA (US)

(21) Appl. No.: 18/193,434

(22) Filed: Mar. 30, 2023

Related U.S. Application Data
(60) Provisional application No. 63/331,348, filed on Apr. 15, 2022.

(51) Int. Cl. H04N 17/00; G06T 7/80; G01C 21/28; G01C 25/00

(52) U.S. Cl. CPC G01C 25/00; G01C 21/28; G06T 7/80; H04N 17/002; G06T 2207/30252

(57) ABSTRACT

According to one aspect, a method includes obtaining an assembly, the assembly including at least a first assembly sensor and a second assembly sensor of a plurality of assembly sensors, and calibrating the first assembly sensor and the second assembly sensor. The method also includes calibrating the first assembly sensor and the second assembly sensor together, wherein calibrating the first assembly sensor and second assembly sensor together includes placing the assembly in at least a first pose relative to a plurality of calibration targets. The assembly is coupled on a vehicle, and the plurality of assembly sensors are calibrated after coupling the assembly on the vehicle. Calibrating the plurality of assembly sensors after installing the assembly on the vehicle includes causing the vehicle to move relative to the plurality of calibration targets and using the plurality of assembly sensors to make measurements using the plurality of calibration targets.

### PRIORITY CLAIM

This patent application claims the benefit of priority under 35 U.S.C. § 119 to U.S Provisional Patent Application No. 63/331,348, filed Apr. 15, 2022, and entitled “METHODS AND APPARATUSES FOR PERFORMING SENSOR CALIBRATIONS FOR AN AUTONOMOUS VEHICLE,” which is incorporated herein by reference in its entirety.

### TECHNICAL FIELD

The disclosure relates to providing systems for use with autonomous and semi-autonomous vehicles. More particularly, the disclosure relates to providing systems which enable sensors used on autonomous and semi-autonomous vehicles to be efficiently calibrated.

### BACKGROUND

Sensors are used in vehicles to enable the vehicles to operate autonomously in a safe manner. When sensors which facilitate the operation of an autonomous vehicle do not operate with a relatively high level of accuracy, the performance of the autonomous vehicle may be compromised. To substantially ensure that sensors used on an autonomous vehicle are able to operate with an expected level of accuracy, the sensors are calibrated.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a process flow diagram which illustrates an overall method of calibrating sensors associated with an autonomous vehicle in accordance with an embodiment,

FIG. 5 is a process flow diagram which illustrates one method of calibration sensors based on the overall method, e.g., overall method 405 of FIG. 4, in accordance with an embodiment.

FIG. 6A is a block diagram representation of a sensor pod assembly, e.g., sensor pod assembly 324a of FIGS. 2 and 3, in accordance with an embodiment.

FIG. 6B is a block diagram representation of sensors mounted on a body of an autonomous vehicle, e.g., body-mounted sensors 324b of FIG. 3, in accordance with an embodiment.

FIG. 7 is a process flow diagram which illustrates a method of calibrating sensors on a sensor pod assembly, e.g., step 517 of FIG. 5, in accordance with an embodiment.

FIG. 8 is a process flow diagram which illustrates a method of calibrating sensors of an autonomous vehicle after a sensor pod assembly and body-mounted sensors are coupled to the autonomous vehicle, e.g., step 529 of FIG. 5, in accordance with an embodiment.

FIG. 9 is block diagram representation of a system configured to perform calibrations associated with a sensor pod assembly and/or sensors to be mounted on a body of an autonomous vehicle using a robotic apparatus in accordance with an embodiment.

FIG. 10 is a diagrammatic top view representation of a system configured to perform calibrations associated with a sensor pod assembly and/or sensors to be mounted on a body of an autonomous vehicle using a robotic apparatus in accordance with an embodiment.

FIG. 11 is a diagrammatic representation of a timeline associated with calibrating sensors used on an autonomous vehicle in accordance with an embodiment.

FIG. 12 is a process flow diagram which illustrates a method of obtaining metrics used to calibrate sensors used on an autonomous vehicle in accordance with an embodiment.

FIG. 13 is a diagrammatic representation of a timeline associated with processes used to calibrate sensors used on an autonomous vehicle in accordance with an embodiment.

### DESCRIPTION OF EXAMPLE EMBODIMENTS

### General Overview

In one embodiment, a method includes obtaining an assembly, the assembly including at least a first assembly sensor and a second assembly sensor of a plurality of assembly sensors, and calibrating the first assembly sensor and the second assembly sensor. The method also includes calibrating the first assembly sensor and the second assembly sensor together, wherein calibrating the first assembly sensor and second assembly sensor together includes placing the assembly in at least a first pose relative to a plurality of calibration targets. The assembly is coupled on a vehicle. and the plurality of assembly sensors are calibrated after coupling the assembly on the vehicle. Calibrating the plurality of assembly sensors after installing the assembly on the vehicle includes causing the vehicle to move relative to the plurality of calibration targets and using the plurality of assembly sensors to make measurements using the plurality of calibration targets.

According to another embodiment, logic is encoded in one or more tangible non-transitory, computer-readable media for execution. When executed, the logic is operable to calibrate a first assembly sensor of a plurality of assembly sensors included in an assembly configured to be attached to a vehicle before attaching the assembly to the vehicle, and to calibrate a second assembly sensor of the plurality of assembly sensors before attaching the assembly to the vehicle; The logic is also operable to calibrate the first assembly sensor and the second assembly sensor together when the assembly is placed in at least a first pose relative to a plurality of calibration targets. Finally, the logic is operable to calibrate the plurality of assembly sensors and includes logic operable to obtain measurements from the plurality of assembly sensors and to process the measurements.

In accordance with still another embodiment, a system includes a robotic apparatus, a plurality of calibration targets, and a calibration server arrangement. The robotic apparatus is configured to support at least one sensor and to physically manipulate the at least one sensor within a range defined substantially about the robotic apparatus. The plurality of calibration targets includes at least a first calibration target and at least a second calibration target, wherein the first calibration target is arranged at a first distance away from the robotic apparatus and the second calibration target is arranged at a second distance away from the robotic apparatus. The calibration server arrangement is configured to cause the robotic apparatus to physically manipulate the at least one sensor to a plurality of different poses, the calibration server arrangement further configured to command the sensor to collect measurements and to process the measurements.

A robotic apparatus such as a robotic arm may be used to perform sensor calibrations of a sensor pod assembly that is to be installed on an autonomous vehicle. Simulations may be performed to determine substantially optimal calibration distances between sensors included in the sensor pod assembly and calibration targets, as well as to determine poses for the sensor pod assembly, for use in a calibration process of the sensor pod assembly. The robotic apparatus may be programmed and configured to substantially automatically position and orient the sensor pod assembly in accordance with the determined calibration distances and/or poses for performing the calibrations. In addition, calibrations of sensors mounted on a body of the autonomous vehicle may also be performed using the robotic apparatus. Calibrations between sensors onboard the sensor pod assembly and sensors mounted on the body of the autonomous vehicle may be performed after the sensors and the sensor pod assembly are installed on the autonomous vehicle. Such calibrations may involve the use of a rotating platform or turntable to rotate the autonomous vehicle, as well as a particular pattern to be driven by the autonomous vehicle.

### DESCRIPTION

Autonomous, as well as semi-autonomous, vehicles generally utilize sensors in order to operate. To effectively ensure the accurate operation of sensors such as lidars, radars, and/or cameras, the sensors are calibrated. The calibration of sensors installed on or otherwise used with autonomous vehicles may utilize multiple processes and apparatuses, with each process being substantially specific to a particular sensor. As a result, the calibration of sensors may often be tedious and time consuming.

An overall system which calibrates sensors prior to installing or otherwise coupling the sensors to a vehicle, and then performs additional calibrations after installation or coupling, may include the use of a robotic apparatus which moves the sensors to different positions in approximately six degrees of freedom, the use of a turntable to move the vehicle into different positions once sensors are installed thereon, and/or the use of a particular pattern to be driven by the vehicle. The use of a robotic apparatus, a turntable, and a pattern to be driven enables sensor calibration to be performed comprehensively, accurately, and efficiently.

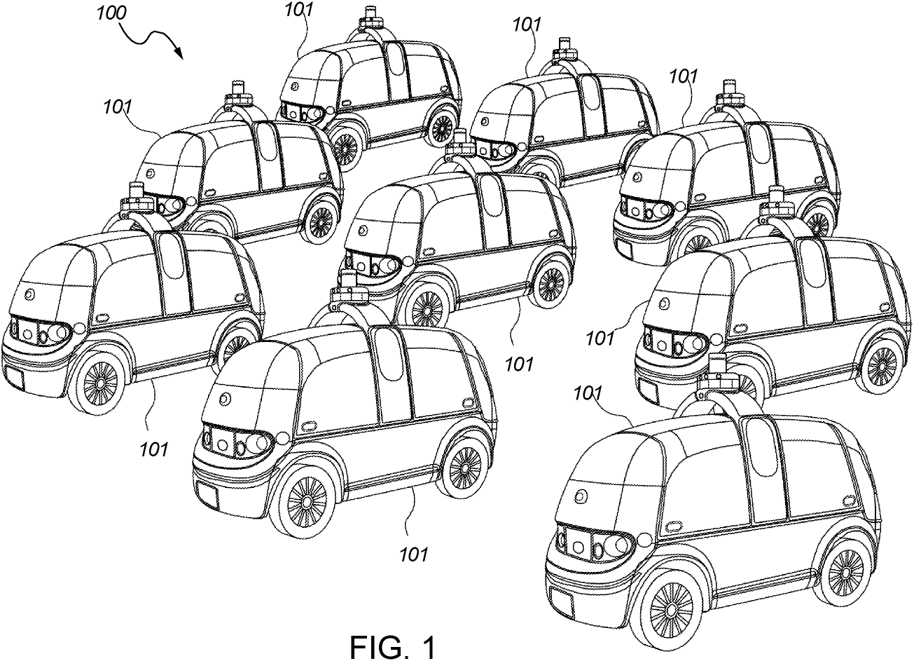

Referring initially to FIG. 1, an autonomous vehicle fleet that may include one or more vehicles with sensors calibrated using a robotic apparatus, turntable, and /or a driving pattern will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

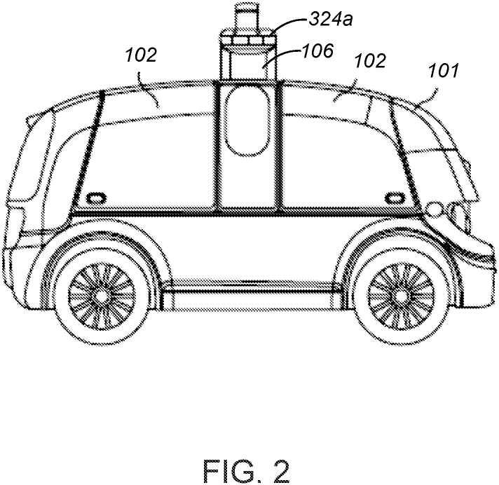

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

Autonomous vehicle 101 also includes a sensor pod assembly 324a that is arranged substantially on top of autonomous vehicle 101. As shown, sensor pod assembly 324a is situated on an arch 106 that is coupled to a surface of autonomous vehicle 101. Sensor pod assembly 324a may include, but is not limited to including, a lidar, a radar, and/or a camera. Sensor pod assembly 324a is generally configured to provide a substantially three-hundred-and-sixty degree view of the environment around autonomous vehicle 101.

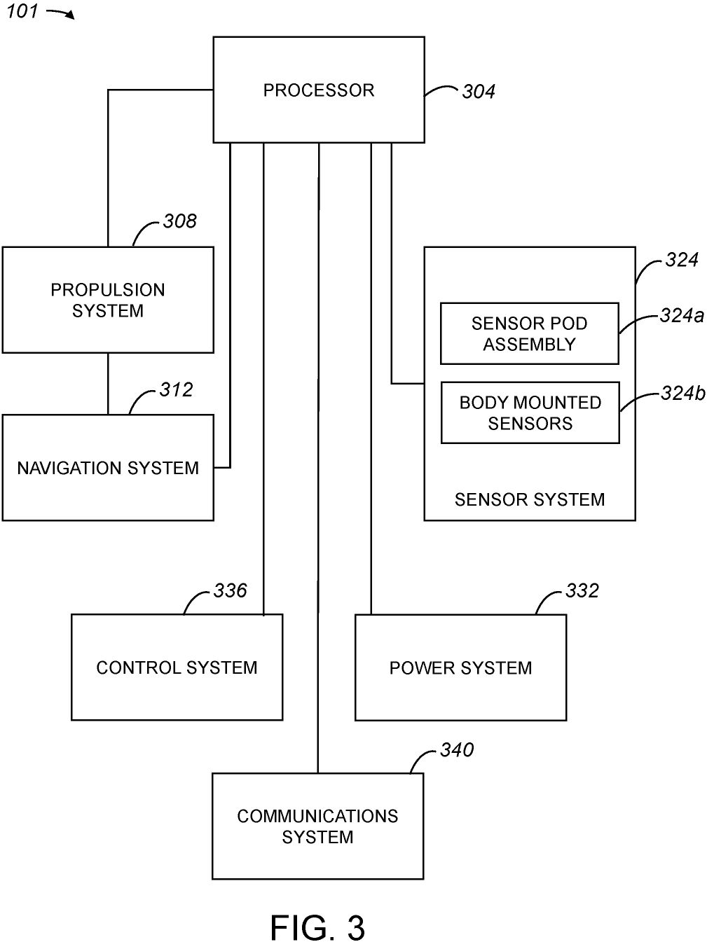

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

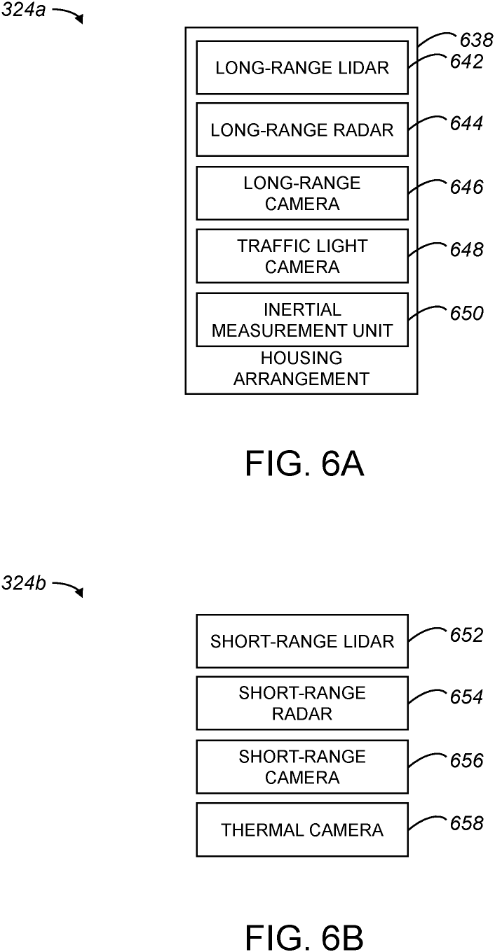

Sensors included in sensor system 324 may include, but are not limited to including, sensors included in sensor pod assembly 324a and body-mounted sensors 324b, or sensors mounted on a body of autonomous vehicle 101. Sensor pod assembly 324a includes sensors such as one or more long-range lidars, one or more long-range radars, one or more long-range cameras, one or more traffic light cameras, and/or an inertial measurement unit, as will be discussed below with respect to FIG. 6A. Body-mounted sensors 324b generally include one or more short-range lidars, one or more short-range radars, one or more short-range cameras, and one or more thermal cameras. Body-mounted sensors 324b will be described in more detail below with respect to FIG. 6B.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived. Because the accuracy of data or information obtained from sensor system 324 is crucial, as such data or information is used by perception and autonomy systems of autonomous vehicle 101, sensors included in sensor system 324 undergo a calibration process.

Sensors that are included in sensor pod assembly 324a may be tested and/or calibrated while sensor pod assembly 324a is detached from, or dismounted from. vehicle 101. By testing and/or calibrating sensors included in sensor pod assembly 324 when sensor pod assembly 324a is not installed on vehicle 101, a variety of different poses and/or orientations may be used that may not be readily achievable when sensor pod assembly 324a is mounted on vehicle 101. Similarly, by testing and/or calibrating body-mounted sensors 324b prior to mounting body-mounted sensors 324b to vehicle 101, a variety of different poses and/or orientations may be used to test and to calibrate body-mounted sensors 324b as well. As such, the calibration of sensor pod assembly 234a and body-mounted sensors 234b may be relatively robust. Additionally, in the event that an issue with sensor pod assembly 234a and/or body-mounted sensors 234b is identified during a testing and/or calibration process prior to sensor pod assembly 234a and body-mounted sensors 234b being mounted on vehicle 101, the issue may be addressed without having to remove sensor pod assembly 234a and/or body-mounted sensors 234b from vehicle 101.

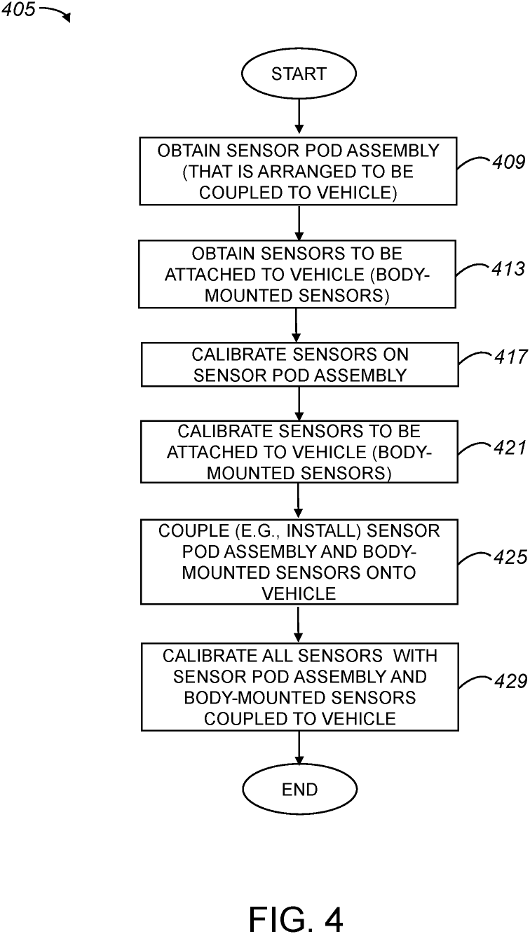

Referring next to FIG. 4, an overall method of calibrating sensors associated with an autonomous vehicle in accordance with an embodiment, A method 405 of calibrating sensors associated with an autonomous vehicle begins at a step 409 in which a sensor pod assembly is obtained. The sensor pod assembly is generally arranged to be coupled to a vehicle, as for example to a sensor arch mounted atop a vehicle and is configured for the sensor pod assembly to mount thereon. As previously mentioned, the sensor pod assembly typically includes multiple sensors.

In a step 413, sensors which are to be attached substantially directly to a vehicle are obtained. Such sensors may generally be body-mounted sensors as, the sensors are arranged to be mounted substantially directly on a vehicle and are not included in a sensor pod assembly. The body-mounted sensors are, in the described embodiment, obtained prior to being mounted on a vehicle.

Process flow moves from step 413 to a step 417 in which sensors included in the sensor pod assembly are calibrated. The sensor pod assembly may be positioned on a robotic apparatus, and the robotic apparatus may move the sensor pod assembly into different positions and/or poses, and collect data using the sensor pod assembly and one or more targets, e.g., calibration targets.

After the sensors in the sensor pod assembly are calibrated, the body-mounted sensors are calibrated in a step 421. Calibrating the body-mounted sensors may include, but is not limited to including, positioning one or more sensors on a robotic apparatus, and using the robotic apparatus to move the one or more sensors to different positions and/or poses. Data may then be collected for calibrations using the one or more sensors and one or more targets.

In a step 425, the sensor pod assembly and the body-mounted sensors are coupled, or installed, onto a vehicle. The sensor pod assembly may be mounted substantially atop the vehicle, while body-mounted sensors may be mounted on a body or a chassis of the vehicle. Once the sensor pod assembly and body-mounted sensors are mounted onto the vehicle, sensors included in the sensor pod assembly and the body-mounted sensors are calibrated in a step 429, and the method of calibrating sensors associated with an autonomous vehicle is completed.

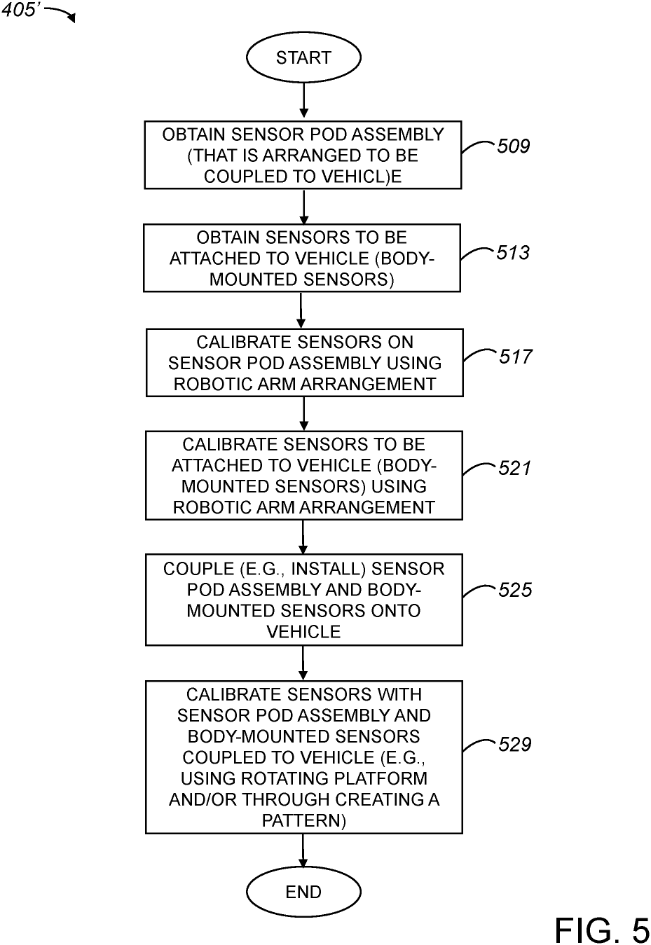

With reference to FIG. 5, one embodiment of overall calibration method 405 will be described. A method 405′ of calibrating sensors associated with an autonomous vehicle begins at a step 509 in which a sensor pod assembly is obtained. From step 509, process flow moves to a step 513 in which sensors which are to be attached to the vehicle are obtained. Such sensors may generally be body-mounted sensors as, the sensors are arranged to be mounted substantially directly on a vehicle and are not included in a sensor pod assembly.

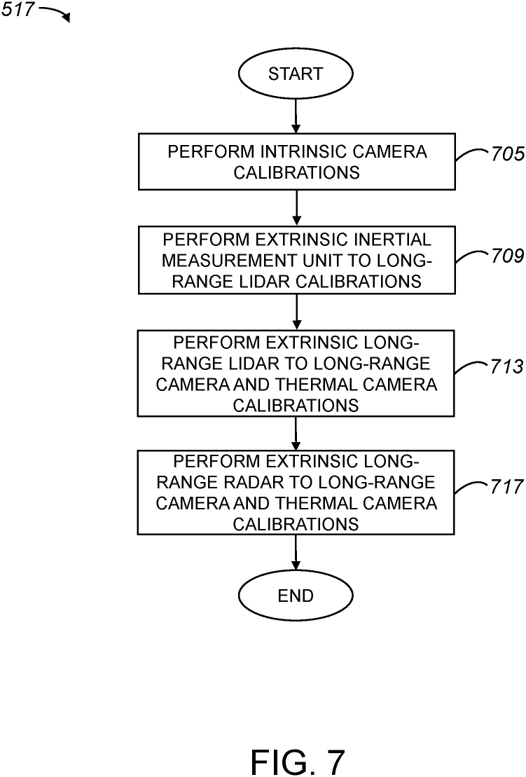

In a step 517, sensors included in the sensor pod assembly are calibrated. The sensor pod assembly may be positioned on a robotic arm which includes multiple degrees of freedom, e.g., approximately six degrees of freedom. The robotic arm may grip or grasp the sensor pod assembly, and physically manipulate the sensor pod assembly into varying positions and poses. The positions and poses may be predefined based on requirements of the sensor pod assembly. Measurements may be taken at each position and pose. The calibration of sensors included in the sensor pod assembly will be discussed below with reference to FIG. 7.

Once the sensors included in the sensor pod assembly are calibrated, the body-mounted sensors may be calibrated in a step 521. Calibrating the body-mounted sensors generally involves gripping or grasping one or more body-mounted sensors at a time using the robotic arm, and manipulating the one or more body-mounted sensors into different positions and poses. Measurements may be taken at each position and pose.

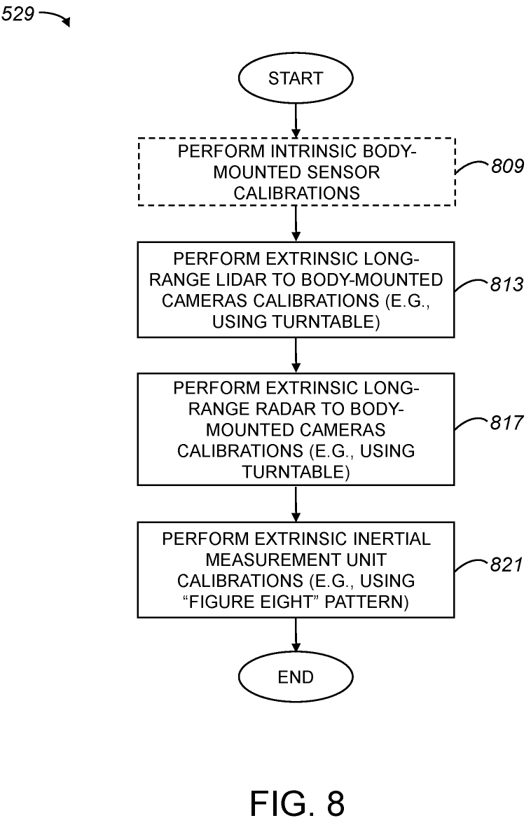

After the body-mounted sensors are calibrated in a step 421, the sensor pod assembly and the body-mounted sensors are installed on or otherwise coupled to the autonomous vehicle, e.g., to a body of the autonomous vehicle. Once the sensor pod assembly and the body-mounted sensors are coupled to the body of the vehicle. The sensors included in the sensor pod assembly and the body-mounted sensors are calibrated in a step 529, and the method of calibrating sensors associated with an autonomous vehicle is completed. The calibration of sensors included in the sensor pod assembly and the body-mounted sensors will be described in more detail below with respect to FIG. 8.

FIG. 6A is a block diagram representation of a sensor pod assembly, e.g., sensor pod assembly 324a of FIGS. 2 and 3, in accordance with an embodiment. Sensor pod assembly 324a is generally arranged to be installed on or otherwise coupled to a top surface of a vehicle, e.g., vehicle 101 of FIGS. 1-3. Sensor pod assembly 324a generally includes a housing arrangement 638 that supports at least one long-range lidar 642, at least one long-range radar 644, at least one long-range camera 646, at least one traffic light camera 648, and at least one inertial measurement unit 650. It should be appreciated that long-range lidar 642, long-range radar 644, and long-range camera 646 are generally considered to provide a relatively long range of view, as for example a view of more than approximately fifteen meters. The positioning and/or poses of long-range lidar 642, long-range radar 644, long-range camera 646, traffic light camera 648, and inertial measurement unit 650 may be substantially constant within housing arrangement 638.

Traffic light camera 648 is configured to detect traffic lights, and to ascertain whether a traffic light is indicating green, yellow, or red. Inertial measurement unit 650 is arranged to collect measurements including, but not limited to, acceleration, forces, and orientations.

FIG. 6B is a block diagram representation body-mounted sensors, e.g., body-mounted sensors 324b of FIG. 3, in accordance with an embodiment. Body-mounted sensors 324b may generally be mounted anywhere on a vehicle, as for example vehicle 101 of FIGS. 1-3. Body-mounted sensors 324b may be carried on a chassis of the vehicle, and may be mounted on an exterior surface associated with the vehicle or within an interior of the vehicle.

Body-mounted sensors 324b include at least one short-range lidar 652, at least one short-range radar 654, at least one short-range camera 656, and at least one thermal camera 658. Short-range lidar 652, short-range radar 654, and short-range camera 656 are configured to collect data, as for example images, that are relatively close to the vehicle on which short-range lidar 652, short-range radar 654, and short-range camera 656 are mounted. For example, short-range lidar 652, short-range radar 654, and short-range camera 656 may be configured to obtain data of surroundings that are less than approximately fifteen meters from the vehicle in some instances, and less than approximately thirty meters from the vehicle in other instances.

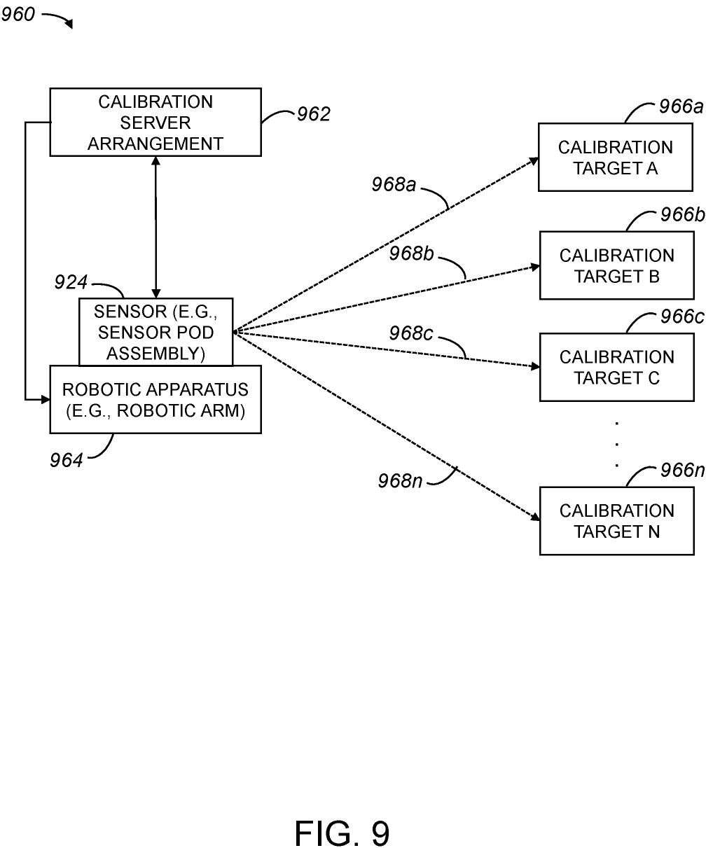

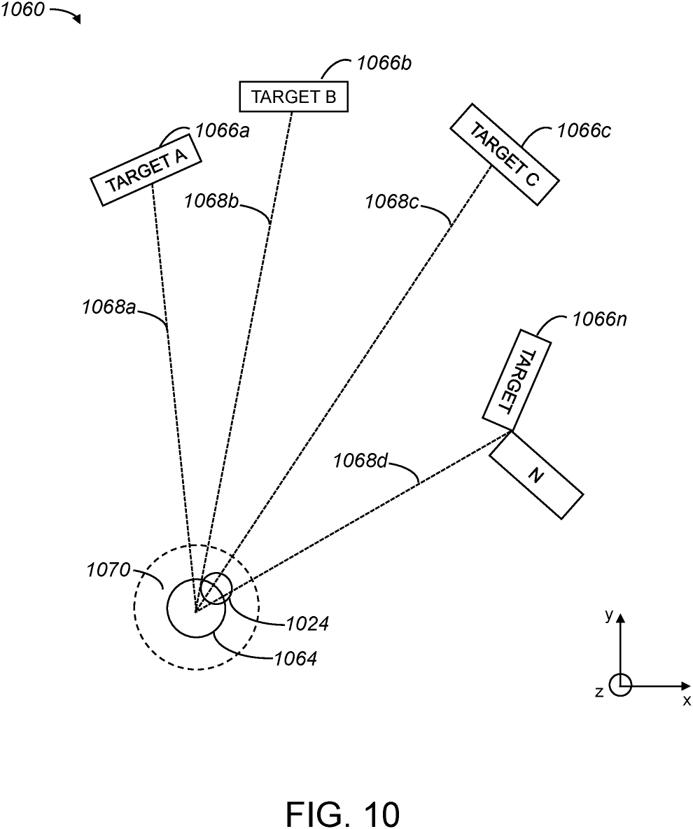

Calibrations of sensors is generally accomplished using one or more calibration targets. The position and/or orientations of sensors with respect to the targets may be changed, and the data collected may be used to calibrate the sensors. The use of targets will be discussed below with respect to FIGS. 9 and 10.

FIG. 7 is a process flow diagram which illustrates a method of calibrating sensors on a sensor pod assembly, e.g., step 517 of FIG. 5, prior to assembling the sensor pod assembly to a vehicle in accordance with an embodiment. Method 517 of calibrating sensors included in a sensor pod assembly begins at a step 705 in which intrinsic camera calibrations are performed. As will be appreciated by those skilled in the art, an intrinsic calibration may be performed to determine one or more intrinsic parameters. Intrinsic parameters of a sensor such as a camera may include, but are not limited to including, parameters that are not dependent upon external factors and the placement of the sensor relative to the external factors. Intrinsic parameters for a camera may include, but are not limited to including, a focal length, a camera protection matrix, and/or distortion parameters, e.g., a radial tangential model and/or a fisheye camera model. In general, different poses and different calibration targets may be used to calibrate the cameras.

Once the intrinsic camera calibrations are performed, extrinsic inertial measurement unit to long-range lidar calibrations are performed in a step 709. As will be appreciated by those skilled in the art, an extrinsic calibration may be performed to determine one or more extrinsic parameters, and extrinsic parameters may include parameters that describe the position and/or orientation of a sensor, e.g., the pose of a sensor, with respect to an external frame of reference. Extrinsic sensor calibrations generally include sensor-to-sensor calibrations performed using pairs of sensors, e.g., a sensor pair that includes an inertial measurement unit and a long-range lidar.

After the extrinsic inertial measurement unit to long-range lidar calibration is performed, process flow moves to a step 713 in which extrinsic long-range lidar to camera calibrations are performed. Such extrinsic calibrations may include a long-range lidar to long-range camera extrinsic calibration and a long-range lidar to thermal camera extrinsic calibration. Lidars and cameras are often utilized together to reconstruct a three-dimensional scene from three-dimensional lidar and two-dimensional camera data. For example, a lidar may capture structural information, while a camera may capture information relating to an appearance. A lidar-to-camera calibration facilitates the fusion of lidar and camera measurements or outputs. A lidar-to-camera calibrations may include, but is not limited to including, converting data from the lidar and data from the camera into the same coordinate system to generate fused data.

In a step 717, extrinsic long-range radar to camera calibrations are performed. For example, a long-range radar to long-range camera extrinsic calibration and a long-range radar to thermal camera extrinsic calibration may be performed. In addition, one or more traffic cameras may also be calibrated. Upon performing the long-range radar to camera calibrations, the method of calibrating sensors included in a sensor pod assembly is completed.

Referring next to FIG. 8, a method of calibrating sensors of an autonomous vehicle after a sensor pod assembly and body-mounted sensors are coupled to the autonomous vehicle, e.g., step 529 of FIG. 5, in accordance with an embodiment. Method 529 of calibrating sensors of an autonomous vehicle begins at an optional step 809 in which intrinsic calibrations of sensors included in a sensor pod assembly and body-mounted sensors may be performed.

In a step 813, extrinsic long-range lidar to body-mounted camera calibrations are performed. The extrinsic long-range lidar to body-mounted camera calibrations may be performed using a turntable or a rotating platform and one or more targets. The vehicle may be placed on the turntable, and the turntable may rotate the vehicle about a vertical axis. As the vehicle rotates, the sensors on the vehicle effectively move to different positions relative to one or more targets.

From step 813, process flow moves to a step 817 in which extrinsic long-range radar to body-mounted cameras calibrations are performed, e.g., with the vehicle on a turntable. After the extrinsic calibrations involving cameras is completed, extrinsic inertial measurement unit calibrations are performed in a step 821. In one embodiment, an extrinsic inertial measurement unit calibration is performed by causing the vehicle to drive in a pattern, as for example a “figure eight” pattern in the vicinity of one or more calibration targets. Once the extrinsic inertial measurement unit calibrations are performed, the method of calibrating sensors of an autonomous vehicle is completed.

A system which calibrates sensors that are to be used on a vehicle prior to mounting the sensors on the vehicle includes a robotic apparatus such as a robotic arm and one or more calibration targets. FIG. 9 is block diagram representation of a system configured to perform calibrations associated with sensors using a robotic apparatus in accordance with an embodiment. A system 960 includes a robotic apparatus 964 that is configured to hold at least one sensor 924. Sensor 924 may be a sensor included in a sensor pod assembly, sensor 924 may effectively be an overall sensor pod assembly, or sensor 924 may be a sensor that is arranged to be mounted substantially directly on a vehicle. In one embodiment, sensor 924 may be onboard a sensor pod assembly 324a of FIGS. 2 and 3, and/or substantially any body-mounted sensor 324b of FIG. 3.

A calibration server arrangement 962 is generally a computing system configured to send, issue, command, or otherwise provide instructions to sensor 924 and to robotic apparatus 964. The instructions may include, but are not limited to including, instructions which inform robotic apparatus 964 how to position or orient itself such that sensor 924 achieves a desired orientation and/or instructions which inform sensor 924 to perform a measurement. Calibration server arrangement 962 may also obtain measurements taken or made by sensor 924 for processing, as for example to ascertain whether sensor 924 is calibrated and/or meets calibration standards. In one embodiment, calibration server arrangement 962 includes hardware and/or software logic which, when executed by one or more processors of calibration server arrangement 962, enables robotic apparatus 964 to be positioned, enables sensor 924 to be activated to collect or to otherwise obtain measurements, and enables the collected measurements to be processed to substantially determine calibrations. In such an embodiment, when calibrations are performed using sensor 924 when sensor 924 is subsequently mounted on a vehicle, calibration server arrangement 962 may obtain and process measurements obtained using sensor 924 when the vehicle is on a rotating platform and/or when the vehicle is driving, e.g., in a figure eight pattern. It should be understood that for calibrations performed using robotic apparatus 964, robotic apparatus 964 may be positioned and/or moved using hardware and/or software logic which is operable to control movement and positioning of robotic apparatus 964. Such logic may be triggered or otherwise controlled by calibration server arrangement 962.

System 960 also includes calibration targets 966a-n. It should be appreciated that the number of calibration targets 966a-n may vary widely, and that the configuration of calibration targets 966a-n may also vary widely. Calibration targets 966a-n may include patterns thereon, e.g., black and white patterns. The patterns may be selected based on requirements of system 960, and may include, but are not limited to including, shapes arranged as a checkerboard and/or a series of circles or dots. Patterns may be formed from colors and/or thermal elements. For example, when sensor 924 is a thermal camera, calibration targets 966a-n may include thermal elements which may be detected by the thermal camera.

Typically, each calibration target 966a-n is substantially located at a predetermined spot within a physical testing area, e.g., a testing area allocated to the testing of sensors 924 as well as an overall autonomous vehicle on which sensor 924 may be subsequently installed. Calibration targets 966a-n are arranged at respective distances 968a-n from sensor 924. Distances 968a-n between sensor 924 and calibration targets 966a-n may be selected based on any suitable criteria including, but not limited to including, desired calibration distances and calibration poses associated with each sensor 924 that is to be calibrated, and specifications associated with sensor 924 such as a focal length of a camera. A calibration pose may be an orientation of a particular sensor assembly relative to, for example, a coordinate system used in performing calibrations or to the calibration target. The coordinate system may be a cartesian coordinate system.

In one embodiment, in addition to, or in lieu of, determining calibration and poses based on desired characteristics and specifications associated with sensor 924, simulations may be performed to determine calibration distances and/or calibration poses. For example, for a particular calibration, simulations may be performed to determine expected sensor measurements for various calibration distances and calibration poses and, as such, desired calibration distance and/or desired calibration poses may be selected and used for a particular calibration. Simulations may be performed to determine calibration distances and/or calibration poses that essentially minimize reprojection errors observed, e.g., when sensor 924 is a camera or a sensor associated with a camera.

The specifications associated with robotic apparatus 964 may also be considered when determining calibration distances and poses. Robotic apparatus 964 may have a specified range of motion within which robotic apparatus 964 may operate. For example, when robotic apparatus 964 includes a robotic arm, the robotic arm may have a specified range of motion within which the robotic arm may operate, and a calibration distance and/or a calibration pose may be selected such that the robotic arm is able to position sensor 924 at a desired distance and at a desired pose.

Each calibration to be performed for sensor 924 may be performed using one or more calibration targets 966a-n, and robotic apparatus 964 may be arranged, e.g., programmed, to substantially automatically reorient sensor 924 with respect to a calibration target 966a-n, as well as to substantially orient sensor 924 from essentially being pointed toward one calibration target 966a-n to the essentially being pointed toward another calibration target 966a-n.

In one embodiment, intrinsic and extrinsic calibrations of sensor 924 includes a series of calibrations performed with respect to one or more calibration targets 966a-n. When sensor 924 is a plurality of sensors associated with a sensor pod assembly, each sensor 924 may be calibrated on an appropriately positioned calibration target 966an. By way of example, a first calibration may be an intrinsic calibration of a long-range camera performed using calibration target A 966a, a second calibration may be an intrinsic calibration of a traffic light camera performed using calibration target B 966b, and a third calibration may be an extrinsic calibration of a long-range lidar to a long-range camera performed using calibration target N 966n. During a calibration process, robotic apparatus 964 may position and/or orient sensor 924 towards one or more calibration target 966a-n such that each individual calibration may be performed.

With respect to each calibration target 966a-n, robotic apparatus 964 may orient sensor 924 in a variety of different poses. For example, when robotic apparatus 964 is a robotic arm with linkages which enable sensor 924 to be grasped and physically manipulated into a variety of different positions and/or poses, robotic apparatus 964 may facilitate measurements that correspond to each different position and/or pose for each calibration target 966a-n.

FIG. 10 is a diagrammatic top view representation of a system configured to perform calibrations associated with a sensor pod assembly or a body-mounted sensor using a robotic apparatus in accordance with an embodiment. A system 1060 includes a robotic apparatus 1064 that is configured to support a sensor arrangement 1024. Sensor arrangement 1024 may be a single sensor, a plurality of sensors, and/or a sensor pod assembly such as sensor pod assembly 324a of FIGS. 2 and 3. Robotic apparatus 1064 may be a robotic arm that is configured to support sensor arrangement 1024, and to enable sensor arrangement 1024 to be positioned and oriented within a range 1070. It should be appreciated that sensor arrangement 1024 may be oriented within range 1070 with respect to a xy-plane, as well as with respect to a xz-plane and/or a yz-plane.

Calibration targets 1066a-n are positioned at distances 1068a-n, respectively, from robotic apparatus 1064. The locations and orientations of calibration targets 1066a-n may vary widely within system 1060.

In general, a sensor pod assembly and body-mounted sensors may be calibrated prior to being installed on or otherwise coupled to a vehicle, as for example using system 960 of FIG. 9. After the calibrated sensor pod assembly and body-mounted sensors are mounted on the vehicle, an additional calibration process may be performed, as for example to further calibrate the sensor pod assembly and the body-mounted sensors prior to the vehicle being deployed. As discussed above, this additional calibration process may include, but is not limited to, rotating the vehicle on a turntable and/or driving the vehicle, as for example in a figure eight pattern, while making measurements. The calibrations performed after a sensor pod assembly and body-mounted sensors are installed on a vehicle may involve using one or more calibration targets.

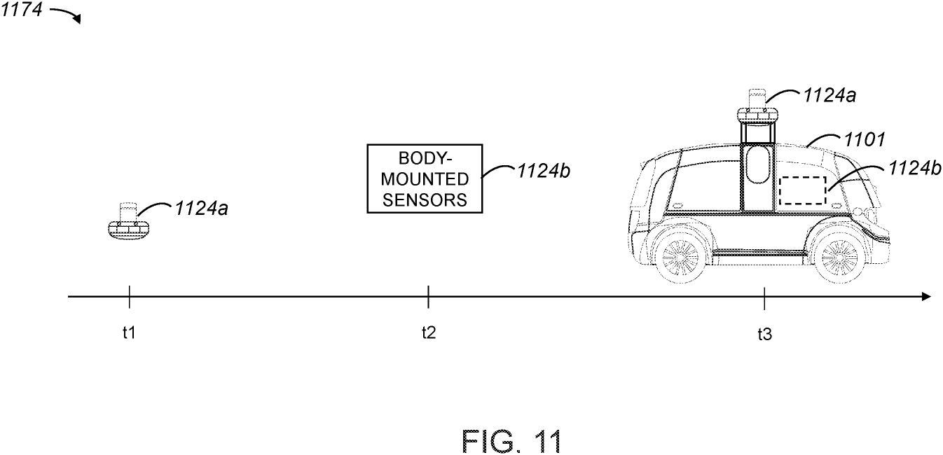

FIG. 11 is a diagrammatic representation of a timeline associated with calibrating sensors used on an autonomous vehicle in accordance with an embodiment. A timeline 1174 indicates that, at a time t1, a sensor pod assembly 1124a is calibrated while not coupled to a vehicle 1101. Calibrating sensor pod assembly 1124a generally involves the use of a system such as system 960 of FIG. 9.

At a time t2, body-mounted sensors 1124b, or sensors which are to be mounted on a body of vehicle 1101 but are not yet mounted on the body of vehicle 1101, are calibrated. The calibration of body-mounted sensors 1124b at time t2 may involve the use of a system such as system 960 of FIG. 9. Body-mounted sensors 1124b may generally include, but are not limited to including, lidars, radars, and cameras such as thermal cameras.

At a time t3, sensor pod assembly 1124a and body-mounted sensors 1124b are installed, or otherwise physically and communicably coupled, to vehicle 1101. Once sensor pod assembly 1124a and body-mounted sensors 1124b are mounted on vehicle 1101 calibrations may be performed with respect to overall vehicle 1101. It should be appreciated that body-mounted sensors 1124b may be mounted substantially anywhere on, or in, a body of vehicle 1101.

The determination or identification of calibration distances and poses to use in a sensor calibration process may involve a consideration of the parameters which are appropriate to determine metrics that are measured during a calibration process. In other words, when identifying suitable calibration distances between a sensor and a calibration target, as well as suitable sensor positions and/or orientations, the parameters associated with the sensors may be considered.

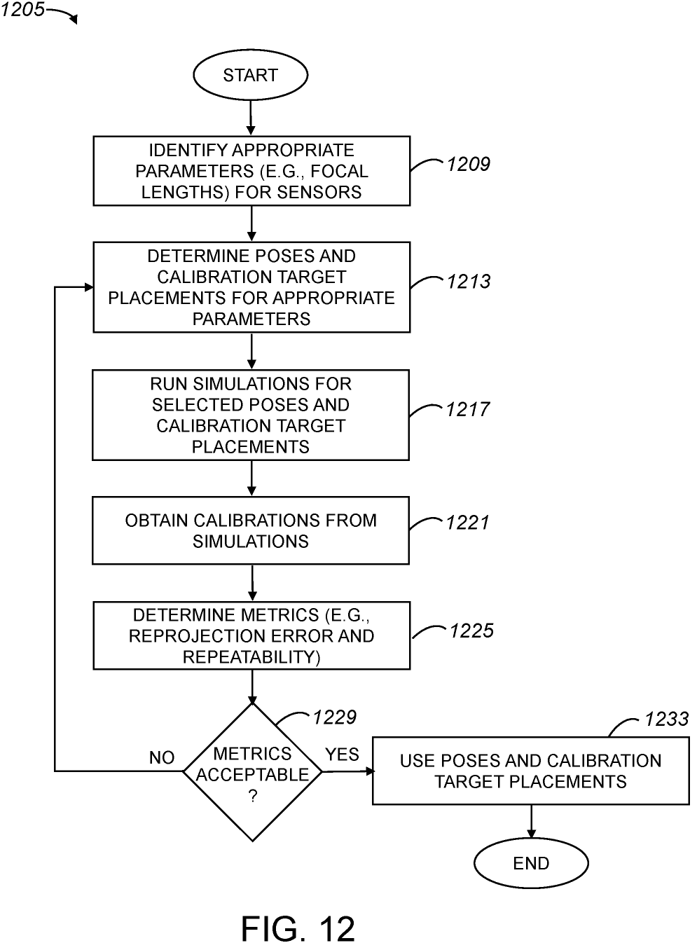

FIG. 12 is a process flow diagram which illustrates a method of obtaining metrics used to calibrate sensors used on an autonomous vehicle in accordance with an embodiment. A method 1209 of obtaining metrics for calibrating sensors begins at a step 1209 in which at least one appropriate parameter for each sensor is identified. The one or more appropriate parameters for each sensor will vary. The appropriate parameter may be, for example, a focal length of a camera that is either part of a sensor pod assembly or is a body-mounted sensor. With respect to lidar, radar and an inertial measurement unit, extrinsic calibrations involve positioning and/or rotating sensors relative to other sensors. In one embodiment, parameters associated with a beam-angle correction and/or approximately six degrees of freedom may be estimated for lidar, parameters associated with range bias and/or yaw may be estimated for radar, and parameters associated with gyroscopic bias and/or rotational degrees of freedom may be estimated for an inertial measurement unit. As will be appreciated by those skilled in the art, rotational degrees of freedom are typically roll, pitch, and yaw.

After the appropriate parameters for sensors are identified, process flow moves to a step 1213 in which poses for each sensor poses and suitable calibration target placements for the appropriate parameters are determined. Such a determination may also include a consideration of the physical attributes of a robotic apparatus which supports sensors and is used to position the sensors during a calibration process.

In a step 1217, simulations may be run for selected poses and corresponding calibration target placements. Simulations may be run, e.g., executed by a processor associated with a computing arrangement which includes hardware and/or software that performs simulations, to simulate measurements associated with sensors if the sensors are subjected to the selected poses and the calibration targets are placed at selected locations.

Once simulations are run, calibrations are obtained from the simulations in a step 1221. Then, in a step 1225, metrics may be determined from the calibrations. The metrics may vary widely. In one embodiment, the metrics may include, but are not limited to including, a reprojection error and repeatability. Upon determining the metrics, a determination is made in a step 1229 whether the metrics are acceptable. That is, it is ascertained whether the selected poses and calibration targets result in acceptable calibration metrics.

If the determination in step 1229 is that the metrics are acceptable, the implication is that a testing system, e.g., testing system 960 of FIG. 9, may be configured with respect to the selected calibration target placements and that sensors may be calibrated using the selected poses. Accordingly, in a step 1233, the selected poses and calibration target placements may be used, and the method of obtaining metrics for calibrating sensors is completed.

Alternatively, if the determination in step 1229 is that the metrics are not acceptable, the indication is that the new poses and/or calibration target placements are to be selected and simulated. As such, process flow returns to step 1213 in which new poses and calibration target placements for the appropriate parameters are determined or otherwise selected.

As will be appreciated by those skilled in the art, real-world repeatability studies may be used to verify that results of a configuration, as obtained from a simulation, are obtained. Adjustments may be made to the configuration based on the real-world repeatability studies. In other words, selected poses and calibration target placements may be adjusted based on information obtained from real-world repeatability studies. Similarly, parameters may be adjusted based on real-world repeatability studies.

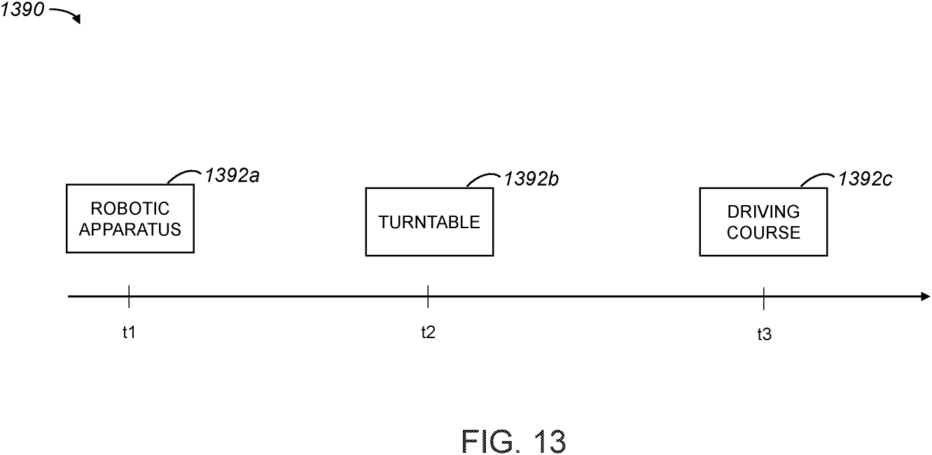

As previously mentioned, an overall sensor calibration process involves the use of a robotic apparatus, a rotating apparatus, and a pattern that is to be navigated. FIG. 13 is a diagrammatic representation of a timeline associated with processes used to calibrate sensors used on an autonomous vehicle in accordance with an embodiment. A timeline 1390 indicates that, at a time t1, a robotic apparatus 1392a is used to calibrate sensors. Robotic apparatus 1392a may be a robotic arm that is configured to engage one or more sensors, and to manipulate the sensors while measurements are taken as part of a calibration process. At a time t2, sensors may be tested using a turntable 1392b or, more generally, a rotating apparatus. Turntable 1392b may be used to facilitate the performance of extrinsic calibrations. In one embodiment, a vehicle on which sensors are mounted may be positioned on turntable 1392b and essentially rotated about a vertical axis by turntable 1392b. At a time t3, a driving course 1392c is used to enable the performance of calibrations. For example, a vehicle may drive a substantially predetermined pattern, as indicated by driving course 1392c, to essentially complete a calibration process.

Although only a few embodiments have been described in this disclosure, it should be understood that the disclosure may be embodied in many other specific forms without departing from the spirit or the scope of the present disclosure. By way of example, while a robotic apparatus such as a robotic arm has been described as being suitable for use in calibrating a sensor pod assembly and body-mounted sensors while the sensor pod assembly and body-mounted sensors are not mounted on a vehicle, the robotic apparatus is not limited to being a robot arm. Additionally, other types of equipment may be used to position and to orient a sensor pod assembly and/or body-mounted sensors.

In general, not every calibration target in a calibration system such as system 960 of FIG. 9 is used to calibrate every sensor. That is, while each sensor that is calibrated may be calibrated based on every calibration target in a calibration system, sensors may instead be calibrated using fewer than all available calibrations targets. For instance, each type of sensor and/or sensor pair that is to be calibrated may be calibrated using a particular substantially dedicated calibration target.

A sensor pod assembly may include components in addition to sensors. For instance, a sensor pod assembly may include sensor cleaning and clearing components. It should be appreciated that such additional components may also be tested and calibrated as part of an overall calibration process that involves sensors included in or otherwise supported by the sensor pod assembly.

In one embodiment, a sensor arch assembly such as sensor arch assembly 106 of FIG. 2 that is configured to support sensor pod assembly 324a may include one or more sensors. In such an embodiment, the sensors in the sensor arch assembly may be calibrated substantially separately. Alternatively, a sensor pod assembly may be assembled with, or otherwise attached to, sensor arch assembly 106 prior to testing and/or calibrating sensors included in the sensor arch assembly. That is, a sensor pod assembly may be coupled to a sensor arch prior to a calibration process, and processes used to calibrate the sensor pod assembly may calibrate any sensors included in the sensor arch, e.g., using a robotic arm.

As previously mentioned, calibration targets may be positioned within a physical testing location or space such that the calibration targets may be used in the performance of calibrations based on the computed calibration distances and/or calibration poses. The locations at which calibration targets are passed may be selected based upon factors including, but not limited to including, specifications or parameters associated with sensors, characteristics of a robotic apparatus such as a robot arm that supports a sensor during a calibration process, information provided by a simulation system, and/or desired calibration distances and/or calibration poses. In one embodiment, the locations at which calibration targets are positioned may selected such that the overall set of calibrations targets may substantially reduce, e.g., essentially minimize, a physical minimize footprint of the overall physical testing space

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining an assembly, the assembly including a plurality of assembly sensors including at least a first assembly sensor and a second assembly sensor;
calibrating the first assembly sensor;
calibrating the second assembly sensor;
calibrating the first assembly sensor and the second assembly sensor together, wherein calibrating the first assembly sensor and second assembly sensor together includes placing the assembly in at least a first pose relative to a plurality of calibration targets;
coupling the assembly on a vehicle; and
calibrating the plurality of assembly sensors after coupling the assembly on the vehicle, wherein calibrating the plurality of assembly sensors after installing the assembly on the vehicle includes causing the vehicle to move relative to the plurality of calibration targets and using the plurality of assembly sensors to make measurements using the plurality of calibration targets.

2. The method of claim 1 further including:
positioning the sensor pod assembly on a robotic apparatus, wherein the robotic apparatus is configured to place the assembly in at least the first pose; and
removing the sensor pod assembly from the robotic apparatus before coupling the assembly on the vehicle.

3. The method of claim 2 wherein calibrating the first assembly sensor includes placing the assembly in at least a second pose relative to the plurality of calibration targets and wherein calibrating the second assembly sensor includes placing the assembly in at least a third pose relative to the plurality of calibration targets.

4. The method of claim 1 wherein calibrating the first assembly sensor includes performing a first intrinsic calibration, and wherein calibrating the first assembly sensor and the second assembly sensor together includes performing a first extrinsic calibration.

5. The method of claim 1 wherein the plurality of sensors includes at least one camera, at least one lidar, at least one radar, and at least one inertial measurement unit.

6. The method of claim 5 wherein the first sensor is one selected from a group including at least one lidar and at least one radar, and wherein the second sensor is the at least one camera.

7. The method of claim 1 further including:
obtaining a first body-mounted sensor, the first body-mounted sensor being separate from the assembly;
calibrating the first body-mounted sensor, wherein calibrating the first body-mounted sensor together includes placing the first body-mounted sensor in at least one pose relative to the plurality of calibration targets; and
mounting the first body-mounted sensor on the vehicle after calibrating the first body-mounted sensor, wherein calibrating the plurality of assembly sensors after coupling the assembly on the vehicle includes calibrating at least one assembly sensor of the plurality of assembly sensors with the first body-mounted sensor.

8. The method of claim 7 wherein the first body-mounted sensor is one selected from a group including at least one lidar, at least one radar, and at least one camera.

9. Logic encoded in one or more tangible non-transitory, computer-readable media for execution and when executed operable to:
calibrate a first assembly sensor of a plurality of assembly sensors included in an assembly configured to be attached to a vehicle before attaching the assembly to the vehicle;
calibrate a second assembly sensor of the plurality of assembly sensors before attaching the assembly to the vehicle;
calibrate the first assembly sensor and the second assembly sensor together when the assembly is placed in at least a first pose relative to a plurality of calibration targets; and
calibrate the plurality of assembly sensors after the assembly is attached to the vehicle, wherein the logic operable to calibrate the plurality of assembly sensors includes logic operable to obtain measurements from the plurality of assembly sensors and to process the measurements.

10. The logic of claim 9, wherein the logic is further operable to cause the assembly to be placed in the at least first pose.

11. The logic of claim 10 wherein the logic operable to calibrate the first assembly sensor is operable to cause the assembly to be placed in at least a second pose relative to the plurality of calibration targets and wherein the logic operable to calibrate the second assembly sensor is further operable to place the assembly in at least a third pose relative to the plurality of calibration targets.

12. The logic of claim 9 wherein the logic operable to calibrate the first assembly sensor is operable to perform a first intrinsic calibration, and wherein the logic operable to calibrate the first assembly sensor and the second assembly sensor together is operable to perform a first extrinsic calibration.

13. A system comprising:
a robotic apparatus, the robotic apparatus configured to support at least one sensor and to physically manipulate the at least one sensor within a range defined about the robotic apparatus;
a plurality of calibration targets, the plurality of calibration targets including at least a first calibration target and at least a second calibration target, wherein the first calibration target is arranged at a first distance away from the robotic apparatus and the second calibration target is arranged at a second distance away from the robotic apparatus; and
a calibration server arrangement, the calibration server arrangement configured to cause the robotic apparatus to physically manipulate the at least one sensor to a plurality of different poses, the calibration server arrangement further configured to command the sensor to collect measurements and to process the measurements.

14. The system of claim 13 wherein the at least one sensor is included in a sensor assembly, the at least one sensor including a first assembly sensor and a second assembly sensor.

15. The system of claim 14 wherein the first assembly sensor is a camera and the second assembly sensor is a lidar, and wherein the calibration server arrangement is configured to command the camera and the lidar to perform a first extrinsic calibration, the first extrinsic calibration being a calibration of the camera and the lidar together, the measurements being associated with the first extrinsic calibration.

16. The system of claim 14 wherein the first assembly sensor is a camera and the second assembly sensor is a radar, and wherein the calibration server arrangement is configured to command the camera and the radar to perform a first extrinsic calibration, the first extrinsic calibration being a calibration of the camera and the radar together, the measurements being associated with the first extrinsic calibration.

17. The system of claim 13 wherein the calibration server arrangement is further configured to position the at least one sensor with respect to a first calibration target of the plurality of calibration targets, and wherein the measurements include a first measurement collected by the sensor with respect to the first calibration target.

18. The system of claim 17 wherein the calibration server arrangement is further configured to position the at least one sensor with respect to a second calibration target of the plurality of calibration targets, and wherein the measurements include a second measurement collected by the sensor with respect to the second calibration target.

19. The system of claim 13 wherein the at least one sensor is arranged to be mounted on a vehicle, and wherein the robotic apparatus is configured to support the at least one sensor and to physically manipulate before the at least one sensor is mounted on the vehicle, the system further including:
a turntable, the turntable being arranged to support the vehicle after the at least one sensor is mounted on the vehicle, the turntable further being arranged to position the vehicle with respect to the plurality of calibration targets, wherein the measurements include a first measurement collected by the sensor with respect to the plurality of calibration targets.

20. The system of claim 13 wherein the calibration server arrangement is configured to process the measurements to determine at least one metric selected from a group including a reprojection error and repeatability.
